(19) United States
(12) Patent Application Publication
(10) Pub. No.: US 2016/0161651 A1
(43) Pub. Date: Jun. 9, 2016

(54) METHOD OF MANUFACTURING POLARIZING FILM AND POLARIZING FILM MANUFACTURED USING THE SAME

(71) Applicants: SAMSUNG ELECTRONICS CO., LTD., Suwon-si (KR); SAMSUNG SDI CO., LTD., Yongin-si (KR)

(72) Inventor: Jong Hoon WON, Yongin-si (KR)

(21) Appl. No.: 14/699,128

(22) Filed: Apr. 29, 2015

(30) Foreign Application Priority Data
Dec. 9, 2014 (KR) 10-2014-0175951

(51) Int. Cl. G02B 5/30; B29D 11/00

(52) U.S. Cl. CPC G02B 5/305; B29D 11/00788; B29K 2105/0032

(57) ABSTRACT

A method of manufacturing a polarizing film includes compressing a melt-blend of a hydrophobic polymer resin and a dichroic dye to manufacture a sheet, disposing the sheet in a water bath, the water bath including an elongation roll, elongating the sheet in the water bath in a uniaxial direction with the elongation roll to manufacture a film, and drying the film.

### CROSS REFERENCE TO RELATED APPLICATIONS

This application claims priority to Korean Patent Application No. 10-2014-0175951 filed on Dec. 9, 2014, and all the benefits accruing therefrom under 35 U.S.C. §119, the entire content of which is incorporated herein by reference.

### BACKGROUND

1. Field

Provided is a method of manufacturing a polarizing film and a polarizing film manufactured using the same are disclosed.

2. Description of the Related Art

A display device such as a liquid crystal display (“LCD”) and an organic light emitting diode (“OLED”) includes a display member such as a display panel and a polarizing plate attached to an outside of the display panel. The polarizing plate is configured to transmit only light of a specific wavelength and to absorb or reflect light of one or more other wavelengths, thus controlling a direction of incident light transmitted onto the display panel or light emitted from the display panel.

The polarizing plate generally includes a polarizer and a protective layer for the polarizer. The polarizer may include or be formed of, for example, polyvinyl alcohol (“PVA”), and the protective layer may include or be formed of, for example, triacetyl cellulose (“TAO”).

### SUMMARY

A polarizing plate including a polarizer and a protective layer not only involves a complicated manufacturing process and relatively high production costs, but also defines a relatively thick polarizing plate which leads to an increased overall thickness of a display device using such polarizing plate. Accordingly, research has been directed to developing a polarizing plate in a film form and omitting the protective layer.

A polarizing film which omits a protective layer is manufactured by melt-blending a hydrophobic polymer resin and a dichroic dye, and then elongating the combination such as with an elongation roll. However, a process of elongation may generate a scratch on the surface of the polarizing film and thus undesirably increase haze therefrom. Therefore, there remains a need for an improved polarizing film for which surface defects are reduced or effectively prevented to decrease or effectively prevent haze therefrom.

Provided is a method of manufacturing a polarizing film having excellent optical properties without damaging a surface of the polarizing film during manufacturing thereof, such as by performing a wet-elongation process to form the polarizing film.

Provided is a polarizing film manufactured according to the method, such that the manufacturing polarizing film which has relatively low surface roughness, for which surface defects such as a scratch is reduced or effectively prevented, and which generates a relatively low haze therefrom.

Provided is a display device including the polarizing film.

Provided is a method of manufacturing a polarizing film, including compressing a melt-blend of a hydrophobic polymer resin and a dichroic dye to manufacture a sheet, disposing the sheet in a water bath, the water bath including an elongation roll, elongating the sheet disposed in the water bath with the elongation roll in a uniaxial direction to manufacture a film, and drying the film.

The hydrophobic polymer resin may include a polyolefin, a polyamide, a polyester, a poly(meth)acrylic resin, a polystyrene, a copolymer thereof, or a combination thereof.

The hydrophobic polymer resin may include polyethylene (“PE”), polypropylene (“PP”), polyethylene terephthalate (“PET”), polybutylene terephthalate (“PBT”), polyethylene terephthalate glycol (“PETG”), polyethylene naphthalate (“PEN”), nylon, a copolymer thereof, or a combination thereof.

The dichroic dye may be included in an amount of about 0.1 part by weight to about 10 parts by weight, for example, about 0.5 parts by weight to about 5 parts by weight, based on 100 parts by weight of the hydrophobic polymer resin.

According to another embodiment, a polarizing film manufactured according to the above-described method is provided.

The polarizing film has surface roughness of less than or equal to about 70 nanometers (nm) and haze of less than or equal to about 1.0 percent (%).

The polarizing film may have polarizing efficiency of greater than or equal to about 90% at light transmittance of greater than or equal to about 38%, for example, greater than or equal to about 40%.

According to another embodiment, a display device includes a display member configured to display an image, and the above-described polarizing film disposed on the display member, is provided.

### BRIEF DESCRIPTION OF THE DRAWINGS

These and/or other features will become apparent and more readily appreciated from the following description of the embodiments, taken in conjunction with the accompanying drawings in which:

FIG. 1 is a schematic view showing a process of manufacturing a polarizing film according to an embodiment,

FIG. 2 is a schematic view showing a process of manufacturing a conventional polarizing film,

FIG. 3 is a cross-sectional view showing a liquid crystal display (“LCD”) according to an embodiment, and

FIG. 4 is a cross-sectional view showing an organic light emitting diode (“OLED”) display according to an embodiment.

### DETAILED DESCRIPTION

Embodiments of the present invention will hereinafter be described in detail, and may be easily performed by those who have common knowledge in the related art. However, this disclosure may be embodied in many different forms and is not construed as limited to the exemplary embodiments set forth herein.

In the drawings, the thickness of layers, films, panel s, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, referring to drawings, a process of manufacturing a polarizing film according to an embodiment is described.

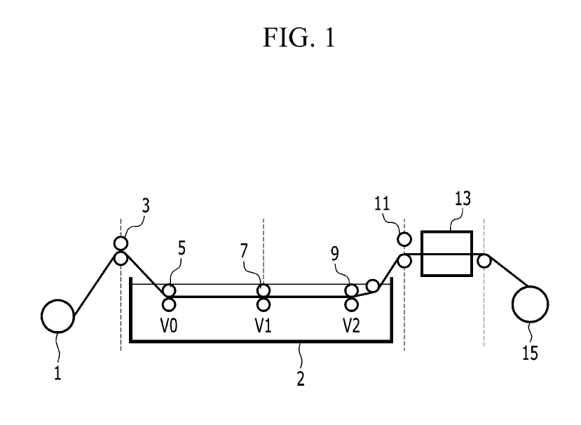

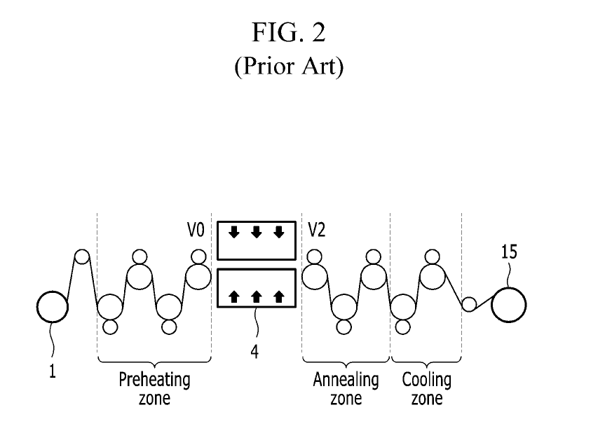

FIG. 1 is a schematic view showing a process of manufacturing a polarizing film according to an embodiment, and FIG. 2 is a schematic view showing a process of manufacturing a conventional polarizing film.

A method of manufacturing a polarizing film according to an embodiment includes compressing a melt-blend of a hydrophobic polymer resin and a dichroic dye to manufacture a sheet, putting the sheet in a water bath including an elongation roll therein, elongating the sheet with the elongation roll in the water bath in a uniaxial direction to manufacture a film, and drying the film.

The melt-blend of the hydrophobic polymer resin and the dichroic dye is obtained by melting a combination of the hydrophobic polymer resin and the dichroic dye at a temperature that is greater than or equal to a melting point (Tₘ) of the hydrophobic polymer resin, for example, at less than or equal to about 300 degrees Celsius (° C.), and for another example, about 130° C. to about 300° C.

As a result, the melt-blend may include a solid content of greater than or equal to about 90 weight percent (wt %) based on a total amount of the melt-blend, for example, about 100 wt % for which the melt-blend effectively includes no non-solid material such as solvent.

The hydrophobic polymer resin may include or be, for example, one among: a polyolefin resin such as polyethylene (“PE”), polypropylene (“PP”) and a copolymer thereof; a polyamide resin such as nylon or an aromatic polyamide; a polyester resin such as polyethylene terephthalate (“PET”), polybutylene terephthalate (“PBT”), polyethylene terephthalate glycol (“PETG”) or polyethylene naphthalate (“PEN”); a poly(meth)acrylic resin such as polymethyl(meth)acrylate (“PMMA”); a polystyrene resin such as polystyrene (“PS”) or an acrylonitrile-styrene copolymer; a polycarbonate resin; a vinyl chloride resin; a polyimide resin; a sulfone resin; a polyethersulfone resin; a polyether-etherketone resin; a polyphenylene sulfide resin; a vinylidene chloride resin; a vinylbutyral resin; an allylate resin; a polyoxymethylene resin; an epoxy resin, a copolymer thereof, or a combination thereof.

In one embodiment, the hydrophobic polymer resin may include or be a polyolefin resin, a polyamide resin, a polyester resin, a poly(meth)acrylic resin, a polystyrene resin, a copolymer thereof, or a combination thereof, for example polyethylene (“PE”), polypropylene (“PP”), polyethylene terephthalate (“PET”), polybutylene terephthalate (“PBT”), polyethylene terephthalate glycol (“PETG”), polyethylene naphthalate (“PEN”), nylon, a copolymer thereof, or a combination thereof.

In another embodiment, the hydrophobic polymer resin may include or be a combination of at least two selected from polyethylene (“PE”), polypropylene (“PP”) and a copolymer of polyethylene and polypropylene (“PE-PP”), and in still another embodiment, a combination of polypropylene (“PP”) and a polyethylene-polypropylene copolymer (“PE-PP”) may be used.

In the above described embodiments, the polypropylene (“PP”) and the polyethylene-polypropylene copolymer (“PE-PP”) may be included in a weight ratio of about 1:9 to about 9:1, about 7:3 to about 3:7, about 4:6 to about 6:4, and more specifically, about 5:5. When the polypropylene (“PP”) and the polyethylene-polypropylene copolymer (“PE-PP”) are included within the above-described range, crystallization of the polypropylene is reduced or effectively prevented such that haze characteristics of the polarizing film are effectively improved and excellent mechanical strength thereof is maintained.

When the hydrophobic polymer resin includes or is polypropylene (“PP”) and a polyethylene and polypropylene (“PE-PP”) copolymer, the content of an ethylene group therein may be about 1 wt % to about 50 wt %, and specifically about 1 wt % to about 25 wt %, based on the total amount of the copolymer. When the polyethylene-polypropylene copolymer (“PE-PP”) includes an ethylene group within the above-described range, phase separation of the polypropylene and the polyethylene-polypropylene copolymer (“PE-PP”) may be effectively prevented or ameliorated. In addition, polarization characteristics of the polarizing film may be improved by increasing an elongation rate during an elongation process, while maintaining excellent light transmittance and arrangement of the formed polarizing film.

The hydrophobic polymer resin may have a melt flow index (“MFI”) of about 1 gram (g) per (/) 10 minutes (min) to about 15 g/10 min, specifically about 3 g/10 min to about 12 g/10 min, and more specifically about 5 g/10 min to about 10 g/10 min. Herein, the melt flow index (“MFI”) indicates an amount of a polymer in a melted state flowing per 10 minutes, and relates to viscosity of the polymer in a melted state. In other words, as the melt flow index (“MFI”) is lower, the polymer has higher viscosity, while as the melt flow index (“MFI”) is higher, the polymer has lower viscosity. Within the above-described range, properties of a final product such as a polarizing film formed therefrom as well as workability thereof during manufacturing of such final product may be effectively improved.

The polypropylene (“PP”) may have a melt flow index (“MFI”) of about 2 g/10 min to about 10 g/10 min, and the polyethylene-polypropylene copolymer (“PE-PP”) may have a melt flow index (“MFI”) of about 5 g/10 min to about 15 g/10 min. When the polypropylene (“PP”) and polyethylene-polypropylene copolymer (“PE-PP”) each have a melt flow index (“MFI”) within the above-described range, properties of a final product such as a polarizing film formed therefrom as well as workability thereof during manufacturing of such final produce may be effectively improved.

The hydrophobic polymer resin may have crystallinity of less than or equal to about 50%, for example, about 30% to about 50%. When the hydrophobic polymer resin has crystallinity within the above-described range, the hydrophobic polymer resin may generate lower haze within a final product such as the polarizing film and define excellent optical properties of such final product formed therefrom.

The manufacturing of the melt-blend into a sheet may be performed by putting the melt-blend in a mold and applying a relatively high pressure to the melt-blend in the mold to compress the melt-blend, or discharging the melt-blend into a die such as a T-die and forming a sheet from discharged melt-blend such as with a chill roll. The melt-blending and the sheet-manufacturing may be performed in a step by step process such as by using a melt-extruder. The formed sheet is then disposed in a rolled state such as be rolling thereof and stored in the rolled state.

Referring to FIG. 1, the previously formed, rolled and stored sheet is provided through a sheet supplier 1. The sheet provided through the sheet supplier 1 is transferred to a water bath 2 in which an elongation roll is disposed, via a guide roll 3, and then elongated in a uniaxial direction within the water bath 2. The water bath 2 illustrated in FIG. 1 includes elongation rolls 5, 7 and 9 disposed therein. Three elongation rolls 5, 7 and 9 are exemplarily shown but, any of a number such as one to four elongation rolls may be used without a particular limit. Referring to the process of manufacturing a polarizing film according to an embodiment, the number of elongation rolls is remarkably reduced as compared with the number of elongation rolls used in a wet process for a conventional PVA-based polarizing film. The reduced number of elongation rolls may decrease or effectively prevent scratches from being formed on the surface of the elongated film during a manufacturing process thereof.

The elongation in a uniaxial direction may be performed at a temperature of about 60° C. to about 85° C., for example, at about 80° C. to about 85° C. Since the elongation in a uniaxial direction is performed with the formed sheet disposed in a water bath 2 in which water is contained, the elongation rolls may not be preheated due to fast heat transfer within the water bath 2 and thus an overall process time is reduced. The elongation in a uniaxial direction may be performed at a relatively low temperature, and herein, a dichroic dye having a relatively low melting point (Tₘ) may be elongated with high orientation.

In contrast, a conventional process of manufacturing a polarizing film shown in FIG. 2 may be performed through preheating (‘Preheating zone’), dry elongation, annealing (‘Annealing zone’), and cooling (‘Cooling zone’) processes. An oven 4 is used for dry elongation instead of the water bath 2 for wet elongation. With the dry elongation employing the oven 4, preheating (‘Preheating zone’) of a formed sheet to be elongated is performed and thus a process time is increased due to the preheating. In addition, the dry elongation employing the oven 4 may generate more scratches or surface defect due to rolling the formed sheet in the preheating process.

In further contrast, a conventional process of manufacturing a polarizing film shown in FIG. 2 uses multiple processes (‘Annealing zone’ and ‘Cooling zone’) after the dry elongation in the oven instead of the drying region 13 shown in FIG. 1. Owing to the additional multiple process, an overall conventional process time is increased as compared to that of the process of manufacturing a polarizing film shown in FIG. 1 employing wet elongation.

In addition, in the process of manufacturing a polarizing film shown in FIG. 1 for wet elongation, when the formed sheet passes over, under and/or between the elongation rolls 5, 7 and 9, the water within the water bath 2 effectively works as a lubricant and provides an elongated film having a uniform thickness. In addition, since the water within the water bath 2 effectively works as a lubricant to the formed sheet, the elongated film may have less scratches on the surface thereof. Accordingly, owing to the elongated film having a uniform thickness and reduced surface defects, a polarizing film formed from the elongated film has relatively low surface roughness and relatively low haze and thus the polarizing film having excellent optical properties may be manufactured.

In addition, in the process of manufacturing a polarizing film shown in FIG. 1 for wet elongation, the elongation in a uniaxial direction does not include a boric acid aqueous solution, unlike in a conventional wet process for manufacturing a PVA-based polarizing film. Since the process of manufacturing a polarizing film according to the invention does not use a boric acid aqueous solution, a wastewater disposal problem of the boric acid aqueous solution is obviated and the process is more environmentally friendly.

The sheet may be elongated at an elongation rate of about 400% to about 1200%. Herein, the elongation rate is obtained as a length ratio of the sheet before and after elongation, and indicates a degree that the sheet is elongated in a uniaxial direction. A desired elongation rate may be obtained by adjusting the elongation rolls 5, 7 and 9. In an embodiment, for example, when V₀ indicates the speed of the elongation roll 5, while V₁ indicates the speed of the elongation roll 7 and V₂ indicates the speed of the elongation roll 9, an elongation ratio of V₂/V₀ may be adjusted to be in a range of about 2.5 to about 9.5, but the present invention is not limited thereto.

The hydrophobic polymer resin may have crystallinity of about 50%, for example, about 30% to about 50%. When the hydrophobic polymer resin has crystallinity within the above-described range, haze of a film formed from the hydrophobic polymer resin may be lowered, and thus excellent optical properties of the formed film may be accomplished.

The hydrophobic polymer resin may have transmittance of greater than or equal to about 85% in a wavelength region of about 400 nanometers (nm) to about 780 nm. Through the elongation process, the hydrophobic polymer resin may be elongated in a uniaxial direction.

The dichroic dye is arranged in one direction along the elongation direction of the hydrophobic polymer resin. The dichroic dye may transmit one polarized perpendicular component from among two polarized perpendicular components in a particular wavelength region.

The dichroic dye may include, for example, an azo-based compound, an anthraquinone-based compound, a phthalocyanine-based compound, an azomethine-based compound, an indigoid or thioindigoid-based compound, a merocyanine-based compound, a 1,3-bis(dicyanomethylene)indan-based compound, an azulene-based compound, a quinophthalonic-based compound, a triphenodioxazine-based compound, an indolo[2,3-b]quinoxaline-based compound, an imidazo[1,2-b]-1,2,4 triazine-based compound, a tetrazine-based compound, a benzo-based compound, a naphthoquinone-based compound, or a compound having the molecular backbone selected from the above compounds.

The dichroic dye may be included in an amount of about 0.1 part by weight to about 10 parts by weight, specifically about 0.5 parts by weight to about 5 parts by weight, based on 100 parts by weight of the hydrophobic polymer. When the dichroic dye is included within the above-described range, a polarizing film having sufficient polarization characteristics without deteriorating transmittance may be provided.

Referring again to FIG. 1, the elongated film in a uniaxial direction is delivered to a drying region 13 via a guide roll 11. The drying region 13 may be operated at a temperature of greater than or equal to about 65° C. to remove water in the elongated film. The drying method employed at the drying region 13 has no particular limit, but may include common hot air drying. The dried elongated film may be transferred to a film receiver 15 via a roll or transferring member disposed between the drying region 13 and the film receiver 15.

The polarizing film obtained in the above-described method is formed as a single (e.g., monolayer) film having a structure in which the hydrophobic polymer resin and the dichroic dye are combined such as by melting and unified through the wet elongation process.

This polarizing film has a relatively low surface roughness of less than or equal to about 70 nm, specifically, less than or equal to about 50 nm, and more specifically, less than or equal to about 25 nm, and haze of less than or equal to about 1.0%, for example, less than or equal to about 0.8%. When the polarizing film has the relatively low surface roughness and a haze within the above-described ranges, the polarizing film may have excellent optical properties.

The polarizing film may have a dichroic ratio ranging from about 2 to about 14 at a maximum absorption wavelength (λₘₐₓ) in a visible light (e.g., wavelength) ray region. The dichroic ratio may be about 3 to about 10 within the above-described dichroic ratio range. Herein, the dichroic ratio may be obtained by dividing absorption of polarized light in a direction perpendicular to the axis of a polymer with absorption of polarized light in a parallel direction according to the following Equation 1.

DR=Log(1/T_{⊥})/Log (1/T_{∥}) Equation 1
In Equation 1,
DR denotes a dichroic ratio of a polarizing film,
T_{∥} is light transmittance of light entering parallel to the transmissive axis of a polarizing film, and
T_{⊥} light transmittance of light entering perpendicular to the transmissive axis of the polarizing film.

The dichroic ratio shows to what degree the dichroic dye is arranged in the polarizing film in one direction. When the polarizing film has a dichroic ratio within the range in a visible ray wavelength region, the dichroic dye is arranged according to arrangement of polymer chains, thus improving polarization characteristics of the polarizing film.

The polarizing film may have polarizing efficiency of greater than or equal to about 90%, for example, about 95% to about 99.99%, with light transmittance of greater than or equal to about 38%, for example, about 40%. Herein, the polarizing efficiency may be obtained according to the following Equation 2.

PE(%)=[(T_{∥}−T_{⊥})/(T_{∥}+T_{⊥})]^{1/2}×100 Equation 2
In Equation 2,
PE denotes polarization efficiency,
T_{∥} is transmittance of light entering parallel to the transmissive axis of a polarizing film, and
T_{⊥} is transmittance of light entering perpendicular to the transmissive axis of the polarizing film.

The polarizing film manufactured according to one or more embodiment of the above-described process of FIG. 1 may be applied to various display devices.

The display device for which the polarizing film manufactured according to one or more embodiment of the above-described process of FIG. 1 may be applied, may be a liquid crystal display (“LCD”).

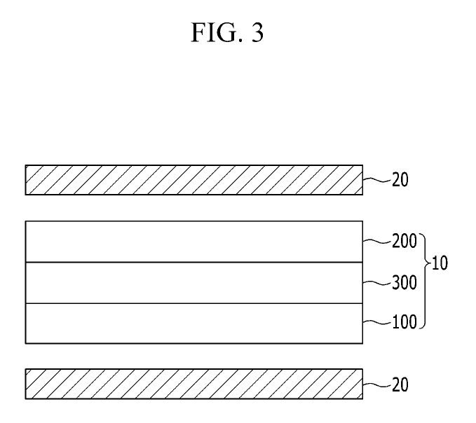

FIG. 3 is a cross-sectional view showing a liquid crystal display (“LCD”) according to an embodiment.

Referring to FIG. 3, the liquid crystal display (“LCD”) includes a liquid crystal panel 10 and a polarizing film 20 disposed on both the lower part and the upper part of the liquid crystal display panel 10. The liquid crystal panel 10 may be considered a display member which is configured to display an image.

The liquid crystal panel 10 may be a twist nematic (“TN”) mode panel, a patterned vertical alignment (“PVA”) mode panel, an in-plane switching (“IPS”) mode panel, an optically compensated bend (“OCB”) mode panel, and the like.

The liquid crystal display panel 10 includes a first display panel 100, a second display panel 200, and a liquid crystal layer 300 interposed between the first display panel 100 and the second display panel 200.

The first display panel 100 may include, for example, a thin film transistor (not shown) disposed on a base substrate thereof (not shown) and a first electric field generating electrode (not shown) connected thereto. The second display panel 200 may include, for example, a color filter (not shown) disposed on a base substrate thereof and a second electric field generating electrode (not shown). However, the embodiment is not limited thereto, and the color filter may be included within the first display panel 100 with both the first electric field generating electrode and the second electric field generating electrode may be disposed within the same first display panel 100.

The liquid crystal layer 300 may include a plurality of liquid crystal molecules. The liquid crystal molecules may have positive or negative dielectric anisotropy. When the liquid crystal molecules have positive dielectric anisotropy, long axes thereof may be aligned substantially parallel to a plane of the first display panel 100 and the second display panel 200 when an electric field is not applied thereto, and may be aligned substantially perpendicular to the surface of the first display panel 100 and the second display panel 200 when an electric field is applied thereto. Conversely, when the liquid crystal molecules have negative dielectric anisotropy, the long axes thereof may be aligned substantially perpendicular to the surface of the first display panel 100 and the second display panel 200 when an electric field is not applied thereto, and may be aligned substantially parallel to the surface of the first display panel 100 and the second display panel 200 when an electric field is applied thereto.

The polarizing film 20 is disposed outside of the liquid crystal display panel 10. Although a polarizing film 20 is shown to be disposed both on the upper part and lower part of the liquid crystal display panel 10 in the drawing, the polarizing film may be disposed on either the upper part or the lower part of liquid crystal display panel 10.

The polarization film 20 includes the polyolefin resin and the dichroic dye which are the same as in the above-described embodiments and repeated discussion will therefore be omitted.

The display device for which the polarizing film manufactured according to one or more embodiment of the above-described process of FIG. 1 may be applied, may be an organic light emitting diode (“OLED”) display.

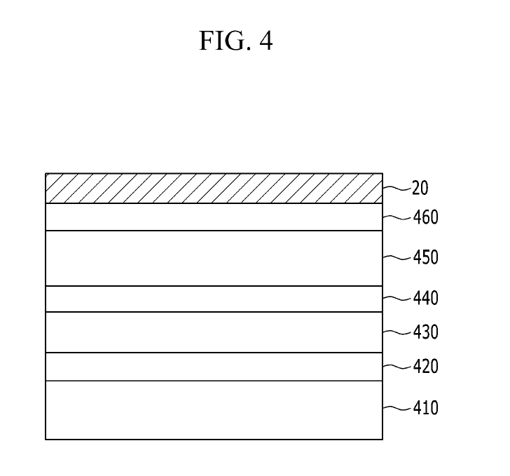

FIG. 4 is a cross-sectional view an organic light emitting diode (“OLED”) display according to an embodiment.

Referring to FIG. 4, an organic light emitting diode (“OLED”) display according to an embodiment of the present invention includes a base substrate 410, a lower electrode 420, an organic emission layer 430, an upper electrode 440, an encapsulation substrate 450, a compensation film 460, and a polarizing film 20. The base substrate 410, the lower electrode 420, the organic emission layer 430, the upper electrode 440, the encapsulation substrate 450 and the compensation film 460 may be considered as collectively forming a display member configured to display an image.

The base substrate 410 may include or be formed of glass or plastic.

Either of the lower electrode 420 and the upper electrode 440 may be an anode, while the other is a cathode. The anode is an electrode where holes are injected, and includes or is formed of a transparent conductive material having a relatively high work function and which externally transmits light entered thereto, for example, indium tin oxide (“ITO”) or indium zinc oxide (“IZO”). The cathode is an electrode where electrons are injected, includes or is formed of a conducting material having a relatively low work function and having no influence on an organic material, and is selected from, for example, aluminum (Al), calcium (Ca), and barium (Ba).

The organic emission layer 430 includes an organic material configured to emit light when a voltage is applied between the lower electrode 420 and the upper electrode 440.

An auxiliary layer (not shown) may be included between the lower electrode 420 and the organic emission layer 430 and between the upper electrode 440 and the organic emission layer 430. The auxiliary layer may include a hole transport layer (“HTL”) for balancing electrons and holes, a hole injection layer (“HIL”), an electron injection layer (“EIL”), and an electron transport layer (“ETL”).

The encapsulation substrate 450 may include or be made of glass, metal or a polymer. The lower electrode 420, the organic emission layer 430 and the upper electrode 440 are sealed by the encapsulation substrate 450 such that inflow of external moisture and/or oxygen thereto may be reduced or effectively prevented.

The compensation film 460 may be configured to circularly polarize light which passes through the polarizing film 20 from outside the display device and generate a phase difference, and thus have an influence on reflection and absorption of the external light incident to the display device. In an embodiment, the phase retardation film 460 may be omitted from the display device.

The polarizing film 20 may be disposed at a light-emitting side or display side of the display device. In an embodiment, for example, the polarizing film 20 may be disposed outside of the base substrate 410 at a lower portion of the display device in a bottom emission type display device in which light emits from the base substrate 410, and/or outside of the encapsulation substrate 450 at an upper portion of the display device in a top emission type display device in which light emits from the encapsulation substrate 450.

The polarizing film 20 may play a role of a light absorption layer absorbing external light and thus reduce or effectively prevent deterioration of a display characteristic of the display device due to reflection of the external light.

Hereinafter, the present invention is illustrated in more detail with reference to examples. However, these examples are exemplary, and the present invention is not limited thereto.

### EXAMPLES 1 TO 5

### Manufacture of Polarizing Films

60 parts by weight of polypropylene (HU300, Samsung Total Petrochemicals Co., Ltd.) and 40 parts by weight of a polypropylene-ethylene copolymer (RJ581, Samsung Total Petrochemicals Co., Ltd.) are combined, and 1 part by weight of a dichroic dye represented by the following Chemical Formulae 1 to 4 is added thereto based on 100 parts by weight of the polyolefin-combination resin. Each dichroic dye is used in the following amounts: 0.200 parts by weight of a dichroic dye represented by the following Chemical Formula 1 (yellow, λₘₐₓ=385 nm, dichroic ratio=7.0), 0.228 parts by weight of a dichroic dye represented by the following Chemical Formula 2 (yellow, λₘₐₓ=455 nm, dichroic ratio=6.5) 0.286 parts by weight of a dichroic dye represented by the following Chemical Formula 3 (red, λₘₐₓ=555 nm, dichroic ratio=5.1), and 0.286 parts by weight of a dichroic dye represented by the following Chemical Formula 4 (blue, λₘₐₓ=600 nm, dichroic ratio=4.5).

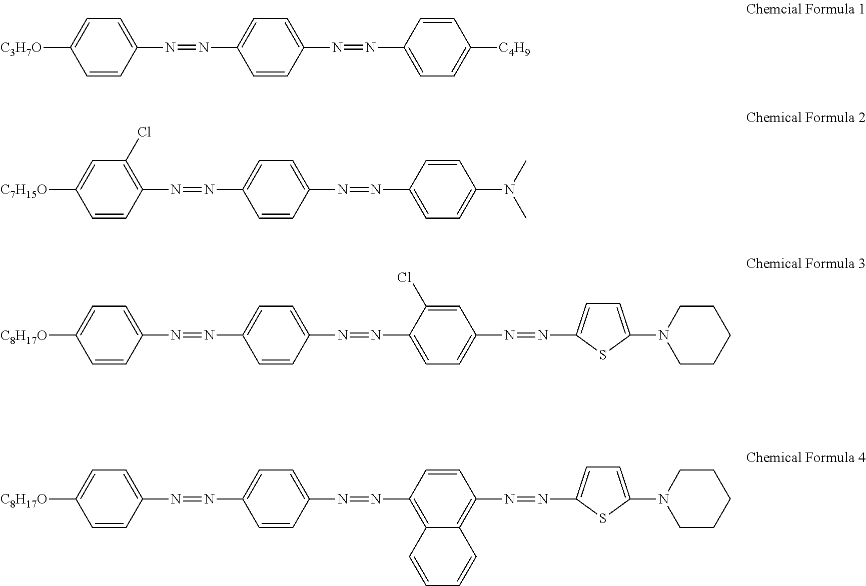

The combination is extruded at a temperature of 230° C. at a screw speed of 40 revolutions per minute (rpm) to, manufacture a sheet.

The manufactured sheet is wet-elongated in 80° C. water according to a wet elongation process shown in FIG. 1, manufacturing the polarizing films according to Examples 1 to 5. Herein, the elongation is adjusted according to a ratio of V₂/V₀ provided in the following Table 1 where V₀ indicates the speed of a first elongation roll (refer to 5 in FIG. 1) and V₂ indicates the speed of a last elongation roll (refer to 9 in FIG. 1).

### COMPARATIVE EXAMPLES 1 TO 5

### Manufacture of Polarizing Film

The manufactured sheet is respectively dry-elongated in a 110° C. oven shown in FIG. 2 to manufacture the polarizing films according to Comparative Examples 1 to 5. Herein, the elongation is adjusted according to a ratio of V₂/V₀ provided in the following Table 1 where V₀ indicates the speed of an elongation roll before passing the oven and V₂ indicates the speed of the elongation roll after passing the oven.

### Property Evaluation of Polarizing Film

The surface roughness (Rq), scratch degree, haze, light transmittance (Ts) and polarizing efficiency of the polarizing films according to Examples 1 to 5 are measured and provided in the following Table 1. The scratch degree is evaluated by examining if there is a scratch or not with the naked eye in a reflection mode after attaching a black tape to the back of a film sample.

The surface roughness (Rq) is measured by using an atomic force microscope (“AFM”), the scratch degree is evaluated with the naked eye, and the haze is measured by using a turbidity meter (NDH-5000, DENSHOKU Co., Ltd.). The light transmittance (Ts) is obtained by respectively measuring light transmittance of a polarizing film with respect to incident light parallel to a transmissive axis and incident light perpendicular to the polarizing film with a UV-VIS spectrophotometer (V-7100, JASCO).

The light transmittance is used to calculate polarizing efficiency (PE) according to Equation 2.

The obtained polarizing efficiency and haze are provided in the following Table 1.

TABLE 1

| | | | | | Light | |
|---|---|---|---|---|---|---|
| | | | | | trans- | Polarizing |
| | | Rq | | Haze | mittance | efficiency |
| | V₂/V₀ | (nm) | Scratch | (%) | (%) | (%) |
| Example 1 | 6.5 | 20.0 | None | 0.8 | 42.8 | 96.0 |
| Example 2 | 7.0 | 20.5 | None | 0.7 | 43.1 | 95.6 |
| Example 3 | 7.5 | 21.7 | None | 0.7 | 43.5 | 95.0 |
| Example 4 | 8.0 | 21.5 | None | 0.6 | 43.8 | 94.7 |
| Example 5 | 8.5 | 21.8 | None | 0.6 | 44.1 | 94.0 |
| Comparative | 7.5 | 74.8 | Generated | 2.2 | 42.3 | 96.0 |
| Example 1 | | | | | | |
| Comparative | 8.0 | 80.1 | Generated | 2.0 | 43.0 | 95.0 |
| Example 2 | | | | | | |
| Comparative | 8.5 | 89.7 | Generated | 1.9 | 43.5 | 94.6 |
| Example 3 | | | | | | |
| Comparative | 9.0 | 90.5 | Generated | 1.7 | 44.0 | 93.0 |
| Example 4 | | | | | | |
| Comparative | 9.5 | 90.2 | Generated | 1.3 | 44.2 | 92.7 |
| Example 5 | | | | | | |

Referring to Table 1, the polarizing films of Examples 1 to 5 show relatively low surface roughness, no scratches, improved haze characteristics, and similar polarizing efficiency at similar light transmittance compared with that the polarizing films according to Comparative Examples 1 to 5.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing a polarizing film, comprising:
compressing a melt-blend of a hydrophobic polymer resin and a dichroic dye to manufacture a sheet;
disposing the sheet in a water bath, the water bath including an elongation roll disposed therein;
elongating the sheet disposed in the water bath, with the elongation roll, in a uniaxial direction to manufacture a film; and
drying the film.

2. The method of claim 1, wherein the hydrophobic polymer resin comprises a polyolefin, a polyamide, a polyester, a poly(meth)acrylic resin, a polystyrene, a copolymer thereof, or a combination thereof.

3. The method of claim 1, wherein the hydrophobic polymer resin comprises polyethylene, polypropylene, polyethylene terephthalate, polybutylene terephthalate, polyethylene terephthalate glycol, polyethylene naphthalate, nylon, a copolymer thereof, or a combination thereof.

4. The method of claim 1, wherein the dichroic dye is included in an amount of about 0.1 part by weight to about 10 parts by weight based on 100 parts by weight of the hydrophobic polymer resin.

5. The method of claim 4, wherein the dichroic dye is included in an amount of about 0.5 part by weight to about 5 parts by weight, based on 100 parts by weight of the hydrophobic polymer resin.

6. A polarizing film manufactured according to the method of claim 1.

7. The polarizing film of claim 6, wherein the polarizing film has surface roughness of less than or equal to about 70 nanometers and haze of less than or equal to about 1.0%.

8. The polarizing film of claim 6, wherein the polarizing film has light transmittance of greater than or equal to about 38% and a polarizing efficiency of greater than or equal to about 90%.

9. A display device comprising:
a display member configured to display an image, and
the polarizing film of claim 6, disposed on the display member.
